(19) United States
(12) Patent Application Publication
(10) Pub. No.: US 2012/0100349 A1
(43) Pub. Date: Apr. 26, 2012

(54) BIODEGRADABLE BARRIER TAPE

(76) Inventor: Roy Keller, Grande Prairie (CA)

(21) Appl. No.: 13/014,142

(22) Filed: Jan. 26, 2011

(30) Foreign Application Priority Data
Oct. 25, 2010 (CA) 2719656

(51) Int. Cl. B32B 3/10; D03D 15/00

(52) U.S. Cl. 428/195.1; 442/1

(57) ABSTRACT

A biodegradable barrier tape in the form of an elongated ribbon of woven plant fibre.

### FIELD

There is described barrier tape that is placed around construction work sites to warn of danger or placed around disaster sites by police, fire and emergency personnel.

### BACKGROUND

Barrier tape is used to mark construction work sites. It is also used by policemen and firemen to make accident, fire and other disaster sites. The barrier tape that currently in use is brightly coloured polymer plastic tape. Recently the use of polymer plastic barrier tape has been questioned, as it takes years to breakdown in landfill sites. What is required is a substitute barrier tape that is biodegradable within a much shorter time span.

### SUMMARY

There is provided a biodegradable barrier tape in the form of an elongated ribbon of woven plant fibre.

The barrier tape, described above, breaks down more rapidly in landfill sites and is, for that reason, more environmentally friendly. While there are various plant fibres that can be used, beneficial results have been obtained through the use of hemp due to its relative strength.

In many cases, a printed message is placed on the barrier tape, such as POLICE, FIRE DEPARTMENT, DANGER DO NOT ENTER, DANGER MEN WORKING, DANGER OPEN EXCAVATION. While there are various inks, dyes, and paints, that can be used to imprint a message on the barrier tape, it is preferred that a vegetable dye be used or some relatively other non-toxic medium.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a front elevation view of a biodegradable barrier tape.

### DETAILED DESCRIPTION

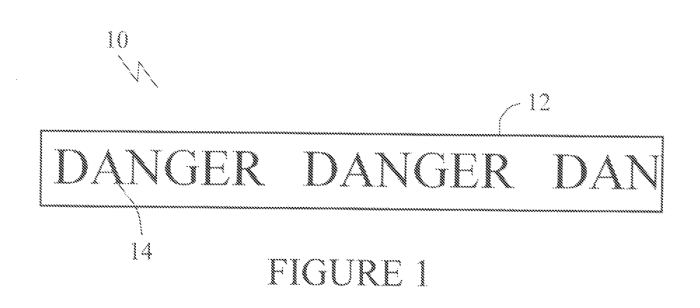

A biodegradable barrier tape generally identified by reference numeral 10, will now be described with reference to FIG. 1.

### Structure and Relationship of Parts:

Referring to FIG. 1, a biodegradable barrier tape 10 is an elongated ribbon 12 of woven plant fibre. In one embodiment, the plant fibre is hemp, however it will be understood that various types of plant fibre may be used. Biodegradable barrier tape 10 has an alpha-numeric message 14 placed on elongated ribbon 12 with vegetable dye.

### Operation:

Referring to FIG. 1, biodegradable barrier tape 10 is made from woven plant fibre and is formed into an elongated ribbon 12. Once formed into elongated ribbon 12, an alpha-numeric message 14 is placed on elongated ribbon 12 using vegetable dye. In the event that biodegradable barrier tape 10 is left in the environment after use, it will harmlessly degrade.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A biodegradable barrier tape, comprising:
an elongated ribbon of woven plant fibre.

2. The biodegradable barrier tape of claim 1, the plant fibre being hemp.

3. The biodegradable barrier tape of claim 1, an alpha-numeric message being placed on the elongated ribbon with vegetable dye.
